(19) United States
(12) Patent Application Publication
(10) Pub. No.: US 2004/0226419 A1
(43) Pub. Date: Nov. 18, 2004

(54) Device to correctly torque nuts and bolts

(76) Inventor: March R. Morgan, Perry, FL (US)

Correspondence Address: Richard C. Litman, LITMAN LAW OFFICES, LTD., P.O. Box 15035, Arlington, VA, 22215, US

(21) Appl. No.: 10/824,604

(22) Filed: Apr. 15, 2004

Related U.S. Application Data
(60) Provisional application No. 60/470,454, filed on May 15, 2003.

(51) Int. Cl. B25B 23/153

(52) U.S. Cl. 81/471

(57) ABSTRACT

A one-time use frangible socket used in combination with a ratchet, pneumatic or hydraulic device, to tighten a bolt, nut or any screw type fastener with a head and threads. The frangible socket has an upper portion for receiving the ratchet, pneumatic or hydraulic device, a lower portion for gripping the head of a bolt, nut or any screw type fastener and a frangible middle portion having a plurality of splines that connect the upper portion and the lower portion together. These splines break at a specified torsion force placed on the frangible socket from the ratchet, pneumatic or hydraulic device, which prevents the ratchet, pneumatic or hydraulic device from stripping the threads on the bolt, nut or any screw type fastener.

### CROSS-REFERENCE TO RELATED APPLICATION

This application claims the benefit of U.S. Provisional Patent Application Serial No. 60/470,454, filed May 15, 2003.

### BACKGROUND OF THE INVENTION

1. Field of the Invention

The present invention relates to a ratchet, pneumatic or hydraulic device attachment with breakaway splines. The ratchet, pneumatic or hydraulic device attachment is made of injection molded plastic and is set to breakaway at a predetermined torsion force.

2. Description of Related Art

Stripping the threads on a bolt, nut or any screw type fastener is a common problem, particularly for mechanics that loosen and remove the head and bolt of a drain plughole of a vehicle's oil pan. Various types of torque shearing breakaway bolt and nut assemblies can be used to prevent stripping in this and other similar situations. These assemblies are also outlined in the related art.

U.S. Patent Application Publication No. 2003/0002950 A1 written by Jameson and published on Jan. 2, 2003, outlines the use of a torsion shearing nut system and method incorporating a hybrid “twistnut” constructed of a metallic force bearing member and a thermoplastic rubber and/or plastic surrounding support member. The present invention permits the use of one or more steel washer inserts formed to permit shearing of an external axial element for the purposes of ensuring the application of a predefined torsion force to the internal axial member.

U.S. Pat. No. 5,176,050 issued to Sauer et al. on Jan. 5, 1993, outlines an improvement in torsion applying tools, namely to tools which can be used to apply a predetermined torsion force to bolts, nuts and analogous components, having a non-circular torsion receiving part. Typical examples of such torque receiving parts are the heads of bolts and the facetted external surfaces of nuts.

U.S. Pat. No. 5,368,480 issued to Balfour et al. on Nov. 29, 1994, outlines the use of a low profile dental torsion ratchet system having a disposable breakaway color coded insert, for holding a tool to be driven by a torsion ratchet wrench. Incorporated within the ratchet wrench is a driver that drives the tool until a preset torsion force shears the insert.

U.S. Pat. No. 5,571,014 issued to Gregory, Jr. et al. on Nov. 5, 1996, outlines a device relating generally to the field of restorative dentistry and more specifically to a prosthodonic torque limiting load spring for tightening dental implants.

U.S. Pat. No. 6,309,154 issued to Higgins on Oct. 30, 2001, outlines the use of a torsion-limiting assembly that includes a collar, a locking ring and a sleeve member. The collar is co-axially and rotatably coupled to a fitting. The locking ring is non-rotatably coupled to the collar and includes a plurality of elongate tangs arranged in a circumference around the ring. The sleeve member is non-rotatably and co-axially coupled to the fitting and has a plurality of contact surfaces that form an outer circumference of the sleeve member.

U.S. Pat. No. 6,439,086 issued to Bahr on Aug. 27, 2002, outlines the use of a torsion limited applicator, useful for a wide variety of purposes where a mechanical device, such as a fastener, is to be driven with a maximum level of torsion force not exceeded. The applicator is reusable and preferably easily constructed from integral pieces of plastic. A torsion-applying element with internal cam followers and a fastener drive structure with a drive element and a cam element, may either be removably positioned with respect to each other or a retaining ring and a deformable pin may attach them together.

UK Patent Application GB 2060452 granted to Schiefer and published on Jul. 5, 1981, outlines the use of a succession of hexagonal elements connected by intervening breaking portions (being formed for instance by spaced circumferential grooves around a hexagonal rod) and a lever, which are engageable with the successive elements for tightening a fastening element having a hexagonal socket in its head. The end most element is inserted into the socket and the lever is engaged with and used to turn the next adjacent element. Instead of being rod-shaped, the elements may be tubular to fit onto units or bolt heads.

Although each of these patents outlines the use of useful and novel devices, what is really needed is a frangible socket that utilizes splines, which breakaway with the application of a predetermined torsion force. Such a device would be in great demand and easy to manufacture and would be well received in the marketplace.

None of the above inventions and patents, taken either singly or in combination, is seen to describe the instant invention as claimed.

### SUMMARY OF THE INVENTION

The invention is a one-time use frangible socket used in combination with a ratchet, pneumatic or hydraulic device, to tighten a bolt, nut or any screw type fastener with a head and threads. The frangible socket has an upper portion for receiving the ratchet, pneumatic or hydraulic device, a lower portion for gripping the head of a bolt, nut or any screw type device's head and a frangible middle portion having a plurality of splines that connect the upper portion and the lower portion together. These splines break at a specified torsion force placed on the frangible socket from the ratchet, pneumatic or hydraulic device, which prevents the ratchet, pneumatic or hydraulic device from incorrectly torqueing a bolt, nut or any screw type fastener. It also prevents stripping the threads on the bolt, nut or any screw type fastener.

Accordingly, it is a principal object of the invention to provide an injection-molded ratchet, pneumatic or hydraulic device attachment that is set to breakaway at a predetermined torsion force.

It is another object of the invention to provide an injection-molded ratchet, pneumatic or hydraulic device attachment that utilizes splines that breakaway at a predetermined torsion force.

It is a further object of the invention to provide a ratchet, pneumatic or hydraulic attachment with breakaway splines, that is easy and inexpensive to make.

Still another object of the invention is to provide ratchet, pneumatic or hydraulic attachments with breakaway splines that are color-coded for different sized ratchet, pneumatic or hydraulic attachments.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an exploded environmental, perspective view of a ratchet, pneumatic or hydraulic device attachment with breakaway splines, according to the present invention.

FIG. 2 is a side perspective view of the ratchet, pneumatic or hydraulic device attachment with breakaway splines.

FIG. 3 is an overhead perspective view of the ratchet, pneumatic or hydraulic device attachment with breakaway splines.

Similar reference characters denote corresponding features consistently throughout the attached drawings.

### DETAILED DESCRIPTION OF THE PREFERRED EMBODIMENT

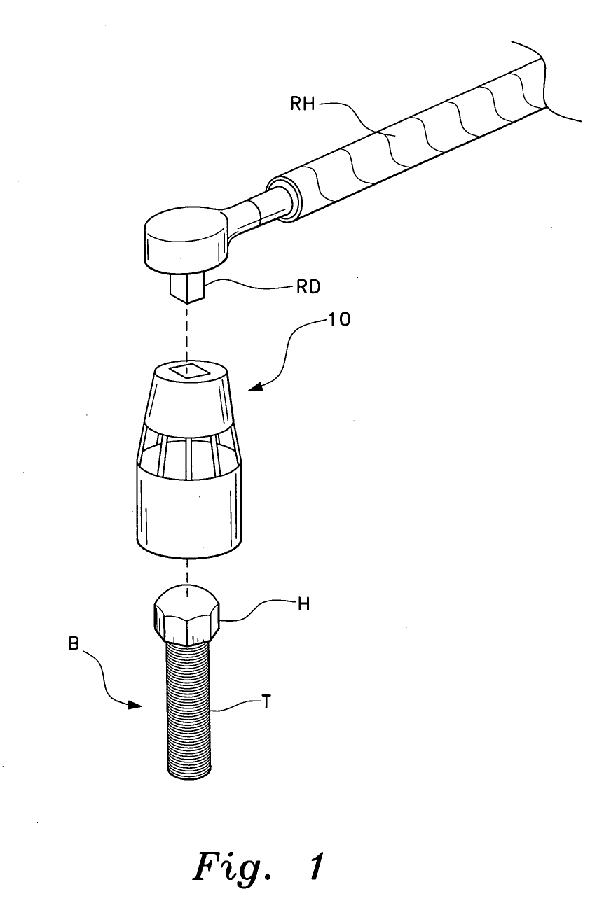

The present invention is a frangible socket 10, used to tighten a bolt, nut or any type of screw-type fastener B with a head H and threads T, as is shown in FIG. 1. The frangible socket 10 can be used in combination with a ratchet, pneumatic or hydraulic device with a ratchet handle RH and ratchet drive RD as is shown in FIG. 1.

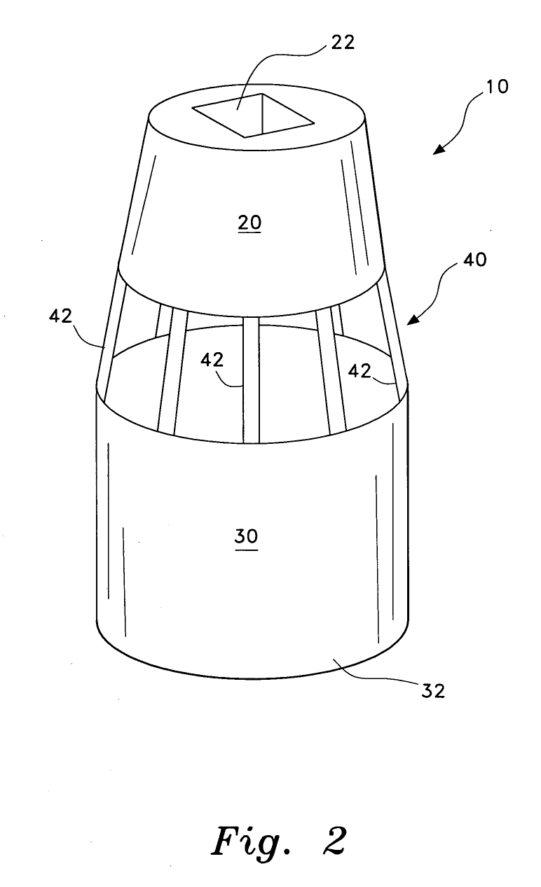

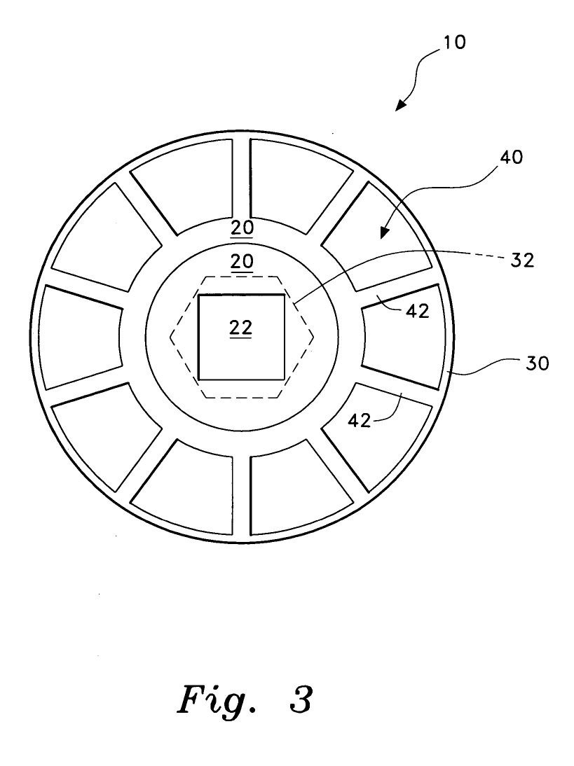

The frangible socket 10 comprises an upper portion 20 for receiving the ratchet, pneumatic or hydraulic device, a lower portion 30 for gripping a bolt, nut or any screw type fastener head H and a frangible middle portion 40 having a plurality of splines 42 that connect the upper portion 20 and the lower portion 30 together. The plurality of splines 42 break at a specified torsion force placed on the frangible socket 10 from the ratchet, pneumatic or hydraulic device, which prevents the ratchet, pneumatic or hydraulic device from stripping the threads T on the bolt, nut or any screw type fastener B. There is an aperture 22 on top of the upper portion 20 to accommodate the ratchet, pneumatic or hydraulic device, as well as a second aperture 32 on the bottom of the lower portion 30, to accommodate the head H of a bolt, nut or any screw type fastener B. Like more traditional socket and ratchet, pneumatic or hydraulic devices, the frangible socket 10 comes in a variety of American and metric sizes. The frangible socket 10 can also come in a variety of predetermined torsion force settings, based on the strength of the plurality of splines 42 of the frangible middle portion 40. These features are depicted in FIG. 2 and FIG. 3.

The frangible socket 10 is made of injection-molded plastic, which is relatively easier and inexpensive to make compared with traditional metal sockets and ratchets. The frangible socket 10 is made to be used once and can also be color-coded according to size. The upper portion 20 of the frangible socket 10 can be conical-shaped or cylindrical-shaped. The frangible socket 10 is designed to breakaway at a predetermined torsion force and to prevent a mechanic from stripping an oil pan drain bolt, while changing the oil of a vehicle. Replacing the entire oil pan is relatively more expensive and costly than just using another one-time frangible socket 10.

Use of the frangible socket 10 is straightforward. The frangible socket 10 can be used with either American or metric sizes and is manually placed onto the ratchet, pneumatic or hydraulic device. Once placed on the ratchet, pneumatic or hydraulic device, the frangible socket 10 is placed over a bolt, nut or any screw type fastener B to be tightened. Once placed over the head H of the bolt, nut or any screw type fastener B, the ratchet, pneumatic or hydraulic device, exerts a torsion force in a clockwise motion, when a user wants to tighten the bolt, nut or any other screw type fastener B. If enough torsion force pressure is placed on the bolt, nut or any other screw type fastener B and the frangible socket 10, the plurality of splines 42 will breakaway and render the frangible socket 10 as being broken and unusable. This is desirable in comparison to stripping an oil pan drain bolt, while changing the oil of a vehicle from applying too much torsion force to the oil pan drain bolt. The frangible socket 10 is designed to be a one-time use item and is considerably less expensive to replace than an entire oil pan. The frangible socket 10 comes in a variety of sizes, to accommodate a variety of bolt, hut or any screw type fastener B sizes and also comes in a variety of predetermined torsion forces.

It is to be understood that the present invention is not limited to the sole embodiment described above, but encompasses any and all embodiments within the scope of the following claims.

I claim:

1. A one-time use frangible socket, used to tighten a bolt, nut and a screw type fastener with a head and threads, comprising:
an upper portion with a top;
a first aperture on the top the upper portion for receiving a ratchet, pneumatic and hydraulic device;
a lower portion with a bottom;
a second aperture on the bottom of the lower portion for gripping the bolt, nut and any screw type fastener head; and
a frangible middle portion having a plurality of splines that connect the upper portion and the lower portion together, which break at a specified torsion force, placed on the frangible socket from the ratchet, pneumatic or hydraulic device, which prevents the frangible socket from stripping the threads on the bolt, nut and any screw type fastener.

2. The frangible socket according to claim 1, wherein the frangible socket is made of injection-molded plastic.

3. The frangible socket according to claim 1, wherein the upper portion is conically shaped.

4. The frangible socket according to claim 1, wherein the upper portion is cylindrically shaped.

5. The frangible socket according to claim 1, wherein the frangible sockets are color-coded to accommodate different bolt, nut or any screw type fastener sizes.

6. The frangible socket according to claim 1, wherein the plurality of splines are each dimensioned and configured to break at different predetermined torsion forces.

7. The frangible socket according to claim 1, wherein the first aperture and the second aperture are in metric sizes.

8. The frangible socket according to claim 7, wherein the first aperture and the second aperture are in American sizes.

9. A one-time use frangible socket used in combination with a ratchet, pneumatic and hydraulic device, to tighten a bolt, nut and a screw type fastener with a head and threads, comprising:
an upper portion with a bottom;
a first aperture on the bottom of the upper portion for receiving the ratchet, pneumatic and hydraulic device;
a lower portion with a bottom;
a second aperture on the bottom of the lower portion for gripping the bolt, nut and any screw type fastener head; and
a frangible middle portion having a plurality of splines that connect the upper portion and the lower portion together, which break at a specified torsion force placed on the frangible socket from the ratchet, pneumatic and hydraulic device, which prevents the frangible socket from stripping the threads on the bolt, nut and any screw type fastener.

10. The frangible socket according to claim 9, wherein the frangible socket is made of injection-molded plastic.

11. The frangible socket according to claim 9, wherein the upper portion is conically shaped.

12. The frangible socket according to claim 9, wherein the upper portion is cylindrically shaped.

13. The frangible socket according to claim 9, wherein the frangible sockets are color-coded based on accommodating different bolt, nut or any screw type fastener sizes.

14. The frangible socket according to claim 9, wherein the frangible sockets break at different predetermined torsion forces.

15. The frangible socket according to claim 9, wherein the first aperture and the second aperture are in metric sizes.

16. The frangible socket according to claim 15, wherein the first aperture and the second aperture are in American sizes.
